(19) United States
(12) Patent Application Publication
(10) Pub. No.: US 2009/0187332 A1
(43) Pub. Date: Jul. 23, 2009

(54) Method for controlling air traffic

(76) Inventor: Joshua Popik Glucoft, Beverly Hills, CA (US)

Correspondence Address: JOSHUA POPIK GLUCOFT, 440 S SPALDING DR, BEVERLY HILLS, CA, 90212, US

(21) Appl. No.: 12/008,999

(22) Filed: Jan. 17, 2008

(51) Int. Cl. G08G 5/00

(52) U.S. Cl. 701/120

(57) ABSTRACT

A method is disclosed for controlling the traffic of flying vehicles. More specifically, a method using a one-to-one function is described that can assign one and only one elevation of travel to each allowable desired direction of travel.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC

Not Applicable

### BACKGROUND OF THE INVENTION

Currently, almost all air travel is in the form of airplanes. The paths of these planes are controlled very tightly by air traffic controllers, both at their departing and arriving locations and also while in the air. A significant amount of resources are dedicated to this management process. At least one explanation for this expenditure is that these airplanes are quite considerable in size, and their speed in conjunction with their lack of agility combine for the necessity of significant planning to avoid potential disasters.

A small percentage of air travel is in the form of helicopters. The amount of helicopter traffic is minimal, however, and the relatively open space combined with the slower speed and high agility of these vehicles makes it feasible to allow pilots to direct themselves when outside the range of Air Traffic Control of the nearest airport.

In the short future, air-based vehicles in one form or another that fill a transportation niche similar to helicopters will become a more common means of transportation for society. If and when public air space becomes commercially managed, as with the recent transition to private ownership of some highways, what will be needed is a structured method to control air traffic that does not require significant third-party input, more specifically, the role of the government.

### BRIEF SUMMARY OF THE INVENTION

The invention is a method that uses a cylindrical coordinate system to direct air traffic. The desired direction of travel (θ) is chosen relative to due north and the vehicle is then directed to be elevated to an altitude (z) that is a function of the desired direction of travel. (In mathematical form, z=f(θ)). The vehicle is then able to travel on the plane specified by the function as long as the directional vector of travel is still the originally desired direction.

### DETAILED DESCRIPTION OF THE INVENTION

To begin, a discrete function must be arranged that assigns an elevation relative to ground level (z) as a function of the desired direction of travel (θ) relative to a chosen polar axis; in the preferred embodiment, the polar axis is due north. In general, if the number of desired directions of travel is limited to some number n, then there are n required elevations; the function is one-to-one. In the preferred embodiment, there are 8 allowable desired directions of travel—0 degrees, 45 degrees, 90 degrees, 135 degrees, 180 degrees, 225 degrees, 270 degrees, and 315 degrees—thereby requiring 8 distinct elevations of travel, each elevation associated with one and only one direction of travel. Each elevation with the exception of the first level must be chosen to ensure that the neighboring plane below is at least the following number of vertical feet below itself: the height of the flying vehicle plus some measure of safety to account for human error in flight as well as physical limitations of the vehicle such as fluid dynamic considerations. In the preferred embodiment, the neighboring planes would have approximately 100 feet between each level. The first elevation level should be chosen such that a significant amount of space is between the first level and any constructions below such as houses or power lines; in the preferred embodiment, the lowest elevation of allowable travel is at 500 feet above ground level.

One clear implication of this invention is the requirement of a spatial cylinder, of some diameter (d) that is at least as wide as the flying vehicles, that intersects each plane of elevation and through which no travel is allowed except in the longitudinal direction of the column itself. These cylinders will be used to allow vehicles on the ground to ascend to the elevation that reflects their desired direction of travel and descend to the ground when they are prepared to use surface roads. In the preferred embodiment, each cylinder would allow only ascending or descending traffic and they would be marked for the driver by selected longitudinal and latitudinal coordinates that would appear on a global positioning system.

Furthermore, the preferred embodiment would have neighboring elevations carry traffic that have the most similar directional paths; for example, if there are 8 directions of travel as in the preferred embodiment, then the elevation for traffic in the direction of 45 degrees should be one level of elevation higher than traffic in the direction of 0 degrees and one level of elevation lower than traffic in the direction of 90 degrees. However, as the nature of the flying vehicle changes, it is vital to keep in mind the particular attributes of the machine; fluid dynamic or heat transfer considerations might recommend that neighboring elevations carry traffic that is most nearly perpendicular or even opposite in direction.

The only adjustment necessary for the pilot is to constantly maintain the elevation of the vehicle as the specified elevation relative to ground level. This adjustment would produce a series of curved elevation planes that allow the function to continue guiding travel even if some obstruction such as a hill or small mountain would otherwise hinder the path of the vehicles. The Earth does have a curvature such that approximately every 6,500 horizontal feet produce a vertical drop of approximately 1 foot, so the pilot will have to adjust their elevation by about one foot for approximately every 1 and ¼ horizontal miles travelled (assuming otherwise flat terrain), which might translate to somewhere on the order of every half of a minute—a manageable feet for any qualified operator of motor vehicles.

Finally, it is important to note that the transformation of functions between cylindrical coordinates and both spherical coordinates and three-dimensional Cartesian coordinates is readily available, so the function may also be defined in these alternate coordinate bases. However, the cylindrical base appears to be the most intuitive form and is therefore the form of the preferred embodiment.

I claim:

1. A method for controlling air traffic using a predetermined function that assigns an elevation at which travel is conducted for each allowable direction of travel.

2. The method for controlling air traffic of claim 1, wherein the function is given in cylindrical coordinates.

3. The method for controlling air traffic of claim 1, wherein the function is given in spherical coordinates.

4. The method for controlling air traffic of claim 1, wherein the function is given in Cartesian coordinates.
